(19) United States
(12) Patent Application Publication
(10) Pub. No.: US 2024/0227240 A9
(43) Pub. Date: Jul. 11, 2024

(54) CUTTING WORKSTATION BLADE AND CARTRIDGE SYSTEM

(71) Applicant: Arrow Fastener Company, LLC, Saddle Brook, NJ (US)

(72) Inventors: Philip Agoglia, Saddle Brook, NJ (US); Gregg MALANGA, Saddle Brook, NJ (US); Bill SOKOL, Saddle Brook, NJ (US); Brendan CRAWFORD, Saddle Brook, NJ (US); Samantha BORRI, Saddle Brook, NJ (US); James SHEPARD, Saddle Brook, NJ (US)

(21) Appl. No.: 17/971,324

(22) Filed: Oct. 21, 2022

(51) Int. Cl. B28D 1/22

(52) U.S. Cl. CPC B28D 1/225

(57) ABSTRACT

Embodiments herein relate to a workstation that includes a cutting tray and one or more rails. The workstation may include a perimeter cutting element configured to travel along the rails, and the perimeter cutting element may include a perimeter blade mounted at least partially within a perimeter cartridge. The workstation may further include a profile cutting element configured to travel along the rails, wherein the profile cutting element includes a profile blade mounted at least partially within a profile cartridge. Other embodiments may be described and/or claimed.

### FIELD

Embodiments of the present invention relate generally to the technical field of cutting devices, and more particularly to a cutting workstation acoustic tile blade and cartridge system.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Acoustic ceiling tile, for example ceiling tile that may be formed of materials such as mineral fiber, fiberglass, wood, metal, melamine acoustic foam, etc. may be manufactured in various shapes and sizes. Therefore, it may be common trim such a ceiling tile prior to use.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 depicts a cutting workstation for acoustic tile, in accordance with various embodiments.

FIG. 2 depicts an alternate view of the workstation of FIG. 1, in accordance with various embodiments.

FIG. 3 depicts an alternative view of the workstation of FIG. 1, in accordance with various embodiments.

FIG. 4 depicts different example schematics of a perimeter blade for use with the workstation of FIG. 1, in accordance with various embodiments.

FIG. 5 depicts an example of a perimeter blade and perimeter cartridge for use with the workstation of FIG. 1, in accordance with various embodiments.

FIG. 6 depicts an example of a perimeter cutting element, in accordance with various embodiments.

FIG. 7 depicts examples of different profile cuts, in accordance with various embodiments.

FIG. 8 depicts an example of a profile blade for use with the workstation of FIG. 1, in accordance with various embodiments.

FIG. 9 depicts example of different components that may be included in a profile cutting element, in accordance with various embodiments.

FIG. 10 depicts an example of a profile cartridge mounting to a profile tray, in accordance with various embodiments.

FIG. 11 depicts an example of installation of profile blades to a profile cartridge, in accordance with various embodiments.

FIG. 12 depicts an example of installation of a profile cartridge to a profile car, in accordance with various embodiments.

### DETAILED DESCRIPTION

As previously described, acoustic ceiling tile may be manufactured in various shapes and sizes. Therefore, it may be common trim such a ceiling tile prior to use. However, trimming the ceiling tile may be time consuming and difficult. For example, it may be difficult to precisely cut the ceiling tile to a given dimension. Similarly, it may be difficult to precisely cut the edges of such ceiling tile to have different profiles. It may also be difficult to precisely cut the ceiling tile based on thickness-related variance in the ceiling tile that results from the manufacturing process of such tile. Finally, it may be difficult to perform such cuts in an efficient manner.

It will be noted that, although embodiments may be described herein with respect to acoustic ceiling tiles, embodiments may likewise be used to cut, shape, or otherwise alter different types of materials such as insulating material, paper, soft wood (e.g., balsa wood), or some other relatively soft and cuttable material.

Embodiments herein may relate to a cutting workstation used to cut acoustic ceiling tiles. The workstation may tiles to size and provide various profiles to the edges of the tiles such as a clean square, slant, or beveled edge to the cut end of the tile. The workstation may utilize one or both of two cutting car mechanisms to make the cuts, a perimeter cutting element and a profile cutting element.

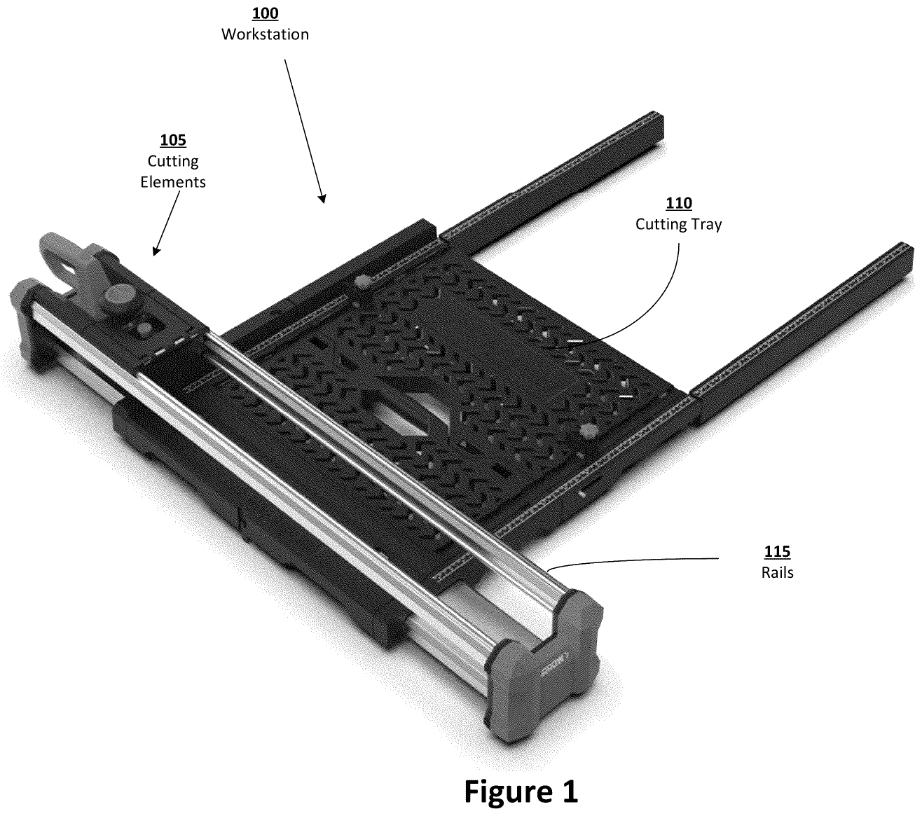

An example workstation is depicted in FIG. 1. Specifically, the workstation 100 may include a cutting tray 110 upon which an acoustic tile may be placed. The acoustic tile may go between the cutting tray 110 and rails 115. Cutting elements 105, e.g., the perimeter cutting element and profile cutting element, may travel along the rails 115 to cut the acoustic tile.

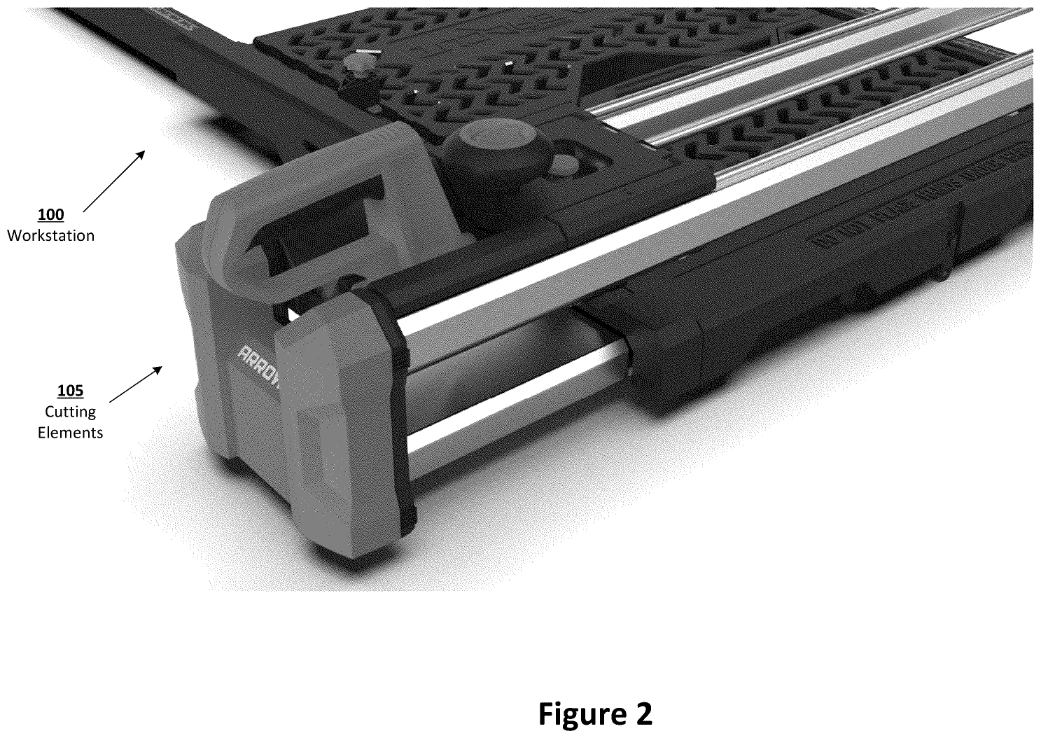

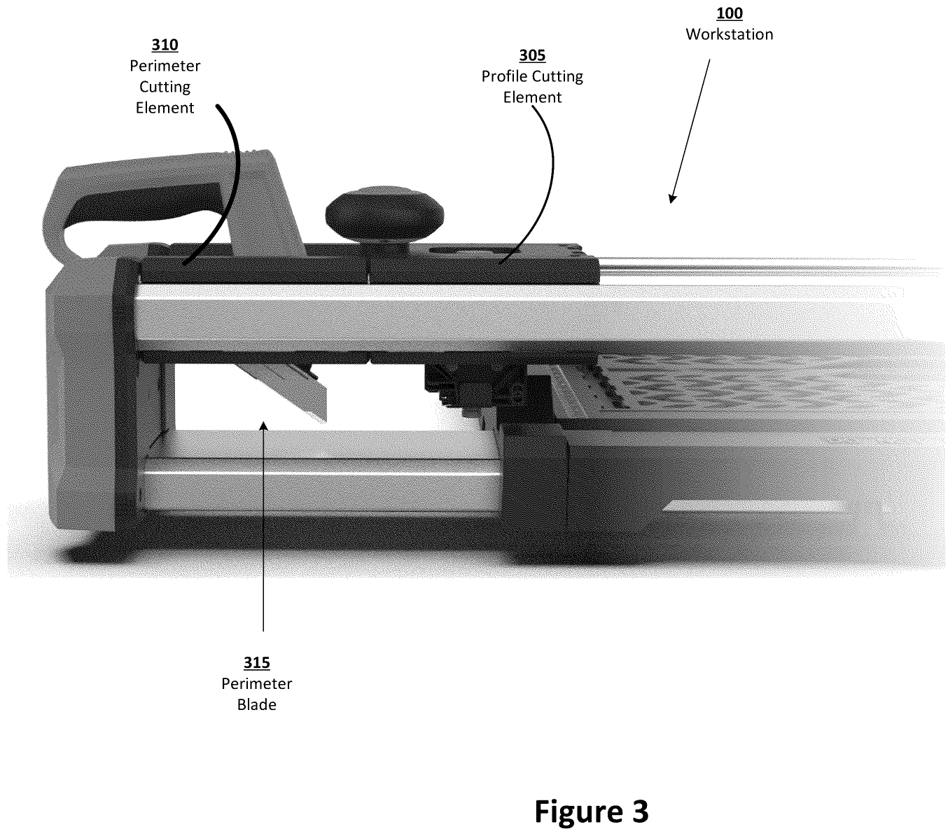

FIGS. 2 and 3 depict alternative views of such a workstation 100 showing an example of how the cutting elements 105 may be aligned at the rails. Specifically, as may be seen in FIG. 3, the cutting elements 105 may include a perimeter cutting element 310 with a perimeter blade 315, and a profile cutting element 305. The perimeter cutting element 310 and the profile cutting element 305 are described in greater detail below.

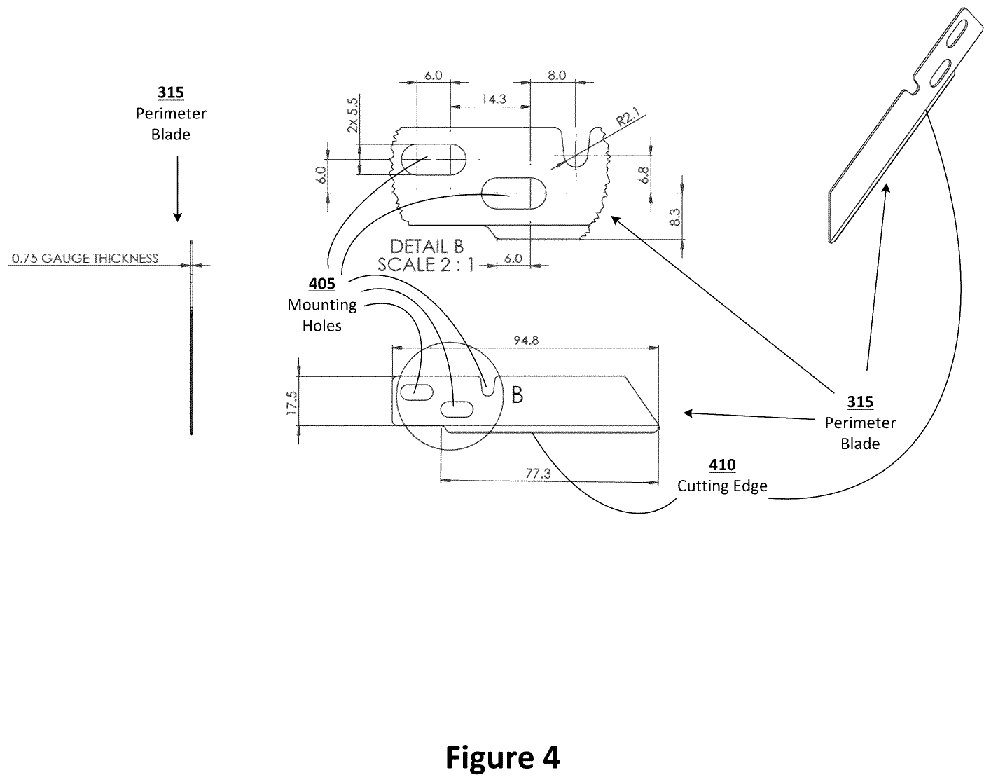

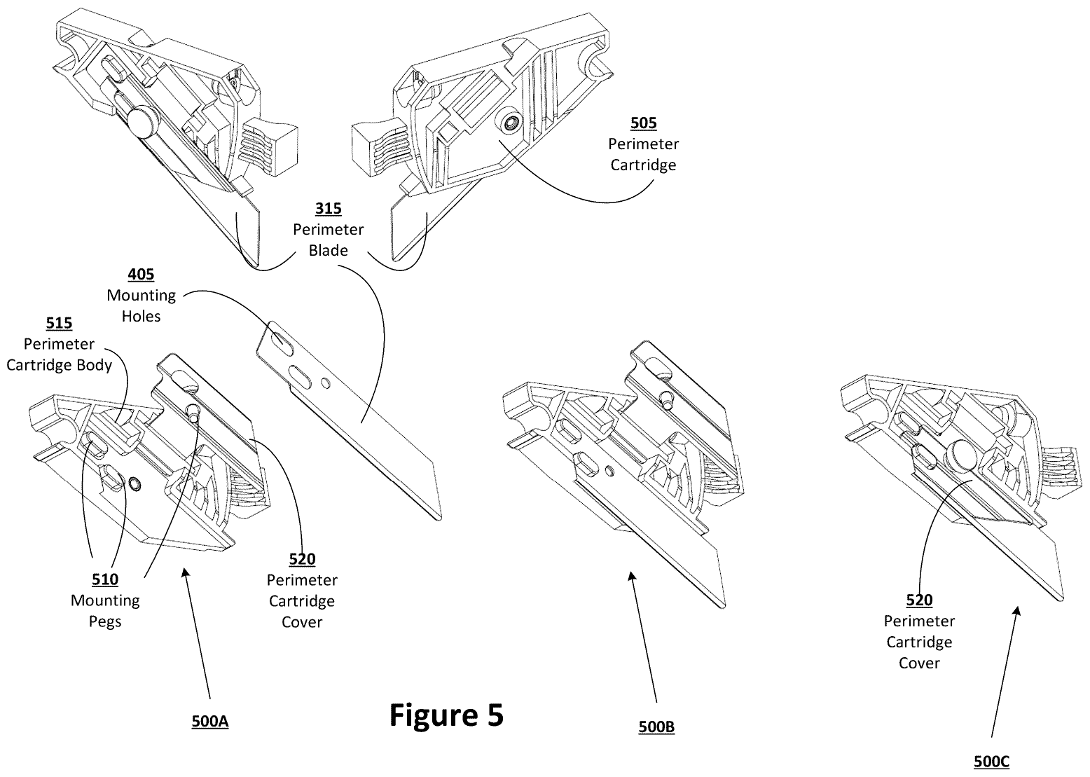

It will be noted that various embodiments of various elements may be shown in the following Figures. For example, the perimeter blade 315 of FIG. 4 may not have the same configuration of mounting holes 405 as the perimeter blade 315 of FIG. 5. This is for the purpose of showing various configurations of such elements. In general, it will be understood that, unless explicitly stated otherwise, the specific size, shape, location, or configuration of various elements may vary in different embodiments or implementations. In other words, the depictions herein are intended as illustrative rather than limiting.

Perimeter Cutting Element—The perimeter cutting element 310 may be configured to couple with one or a plurality of blade holder cartridges and/or perimeter cutting blades which may be designed to cut a range of common ceiling tile thicknesses and materials. For example, ceiling tiles may come in thicknesses such as ⅝″, ¾″, ⅞″, 1″, 1¼ ″ and 1½ ″. As noted above, in some cases the thicknesses may vary based on imprecise manufacturing techniques. In some cases, such variance may be by as much as 1/16″.

Generally, the perimeter blade 315 may be for the purposes of trimming a length or width of an acoustic tile. Specifically, the acoustic tile may be placed on the cutting tray 110 and then the perimeter cutting element 310 may be moved along one or more of the rails 115 while the perimeter blade 315 is lowered (for example, as shown in FIG. 3). The perimeter blade 315 may then cut at least partially through the acoustic ceiling tile in a safe and controlled manner.

FIG. 4 depicts different example schematics of a perimeter blade 315 for use with the workstation 100 of FIG. 1, in accordance with various embodiments. It will be noted that the embodiment depicted in FIG. 4 is intended as one example of such a perimeter blade, and in other embodiments one or more of the depicted measurements may vary. The measurements depicted in FIG. 4 are in units of millimeters (mm).

As may be seen in FIG. 4, the perimeter blade 315 may have a number of mounting holes 405. The mounting holes 405 may be configured to couple with mounting pegs of a perimeter blade cartridge, as will be described in greater detail below. It will be noted that the mounting holes 405 may be sized and shaped such that they have one dimension (e.g., a length as shown in FIG. 4) that is different than another dimension (e.g., a width) of the mounting hole 405. As such, once the blade is mounted with the mounting pegs positioned within the mounting holes 405, rotation of the blade may be limited. Additionally, as may be seen in FIG. 4, various of the mounting holes 405 may be positioned at an interior portion of the perimeter blade 315, while others of the mounting holes 405 may be positioned at an exterior portion of the perimeter blade 315.

The perimeter blade 315 may further have a cutting edge 410 as shown in FIG. 4. The cutting edge 410 may be at least partially coated with Tetrahedral Amorphous Carbon diamond coating (TaC Technology), which may help provide significant hardness increase life span of the cutting edge significantly when cutting through various ceiling tile materials. The cutting edge 410, and the perimeter blade 315 in general, may also a minimum performance requirement of 200 cuts per blade. This performance may be significantly more than standard non-coated utility knife blades. Finally, the blade design may have a rounded edge as shown in FIG. 4 at the tip of the perimeter blade 315.

FIG. 5 depicts an example of a perimeter blade 315 and perimeter cartridge 505 for use with the workstation 100 of FIG. 1, in accordance with various embodiments. Specifically, the perimeter blade 315 may be mounted within the perimeter cartridge 505 as shown in FIG. 5. As may be seen at 500A, the perimeter cartridge 505 may have a perimeter cartridge body 515 and a perimeter cartridge cover 520 which may be configured to open to allow for insertion of the perimeter blade 315 within the perimeter cartridge 505. As may be seen at 500A, the perimeter cartridge 505 may have one or more mounting pegs 510. At 500A, two mounting pegs are attached to the perimeter cartridge body 515, and one may be positioned on the perimeter cartridge cover 520.

At 500B, the perimeter blade 315 and, more specifically, the mounting holes 405 of the perimeter blade 315, may be configured to mate with the mounting pegs 510 of the perimeter cartridge 505 or, more specifically, the mounting pegs 510 of the perimeter cartridge body 515. Then, when the perimeter cartridge cover 520 is closed at 500 C, the mounting peg 510 on the perimeter cartridge cover 520 may couple with a remaining mounting hole 405 of the perimeter blade 315. It will be appreciated that such a mounting mechanism may securely hold the perimeter blade 315 through a variety of securing elements. For example, the use of plural mounting pegs 510, as well as the non-circular shape of the mounting pegs 510, may both hold the perimeter blade 315 in place as well as prevent it from rotating during use.

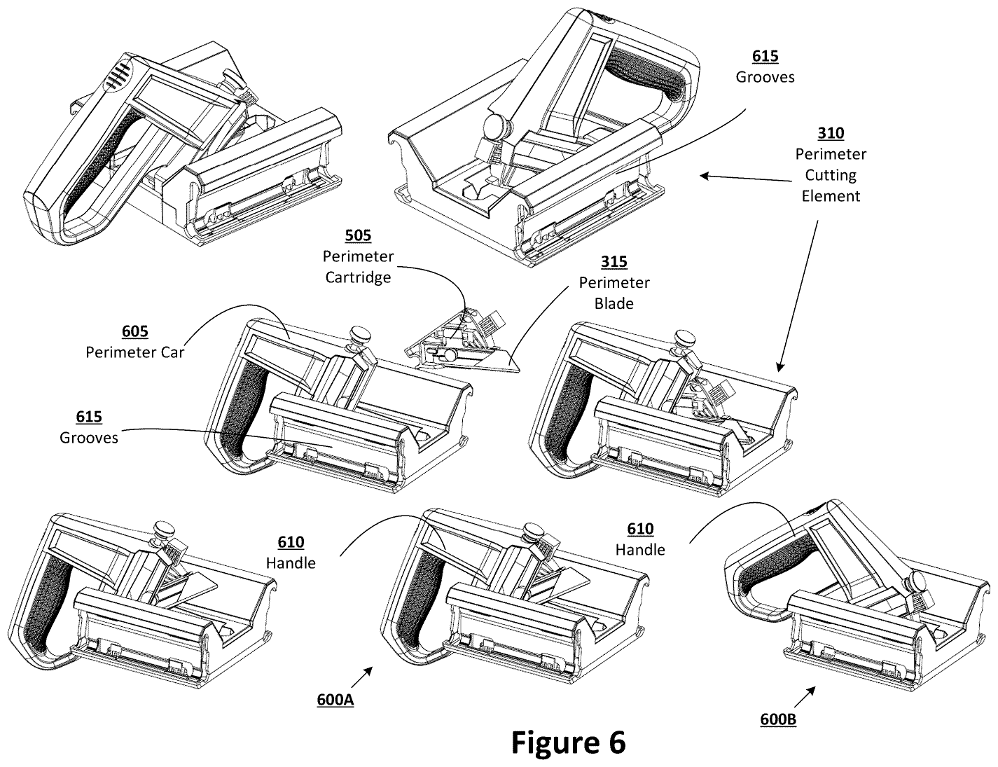

FIG. 6 depicts an example of a perimeter cutting element 310, in accordance with various embodiments. As may be seen, the perimeter cutting element 310 may include a perimeter cartridge 505 with a perimeter blade 315 therein. The perimeter cartridge 505 may be placed within a perimeter car 605. Generally, the perimeter car may be the element that is designed to travel back and forth along rails 115.

As may be seen at 600A and 600B, the handle 610 of the perimeter car 605 may be rotated. By rotating the handle 610, the perimeter blade 315 may be raised (as in 600A) or lowered (as in 600B). When the blade 315 is lowered, then the blade may cut an acoustic tile that is placed on the cutting tray 110 when the perimeter cutting element 310 is moved along the rails 115. When the blade 315 is raised, then the blade may not cut the acoustic tile.

It may also be seen that the perimeter car 605 may include grooves 615 on either side of the perimeter car 605. The grooves 615 may mount with the rails 115 such that the perimeter car 605 may sit between the rails 115. It will be understood that, in other embodiments, a different type of mechanism may be used to assist the perimeter car 605 in sliding along the rails 115. For example, in another embodiment, the perimeter car 605 may sit atop one or more of the rails 115, one or more of the rails 115 may go through the perimeter car 605, etc.

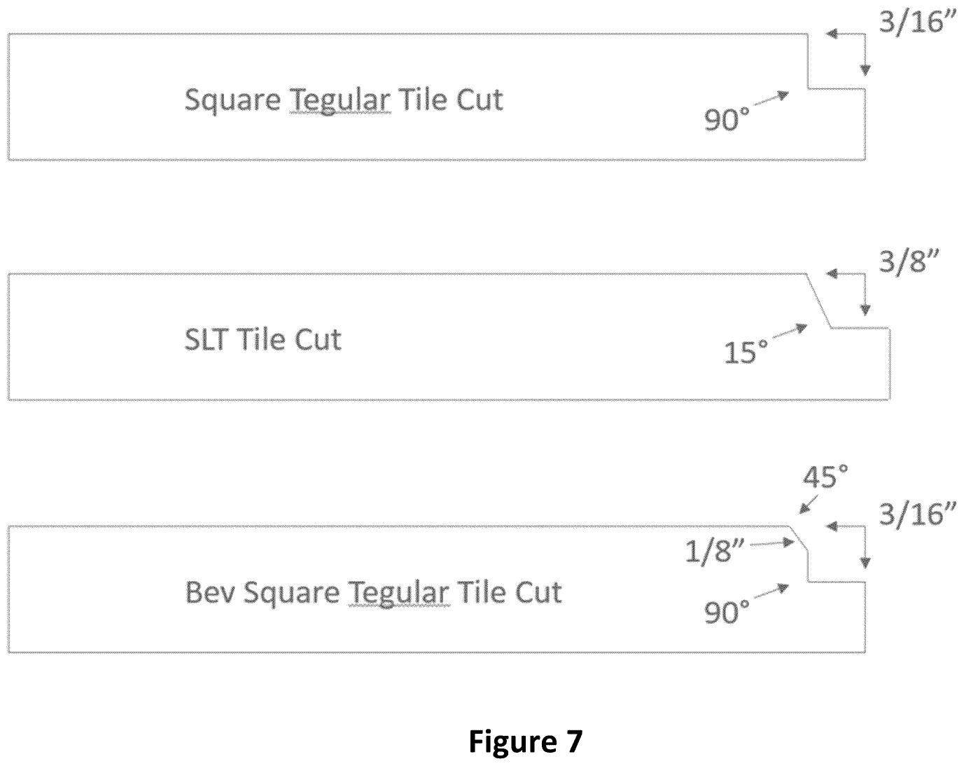

Profile Cutting Car—The profile cutting element 305 may be configured to incorporate a plurality of blade cartridges, color-coded trays, and/or a profile blade. The profile cutting element may be configured to cut a square, slant, or beveled edge on the ceiling tiles, which may produce an edge to the tiles that is similar to that produced by a facility that manufactures the tiles. FIG. 7 depicts examples of different edges include a square tegular tile cut, a slanted (SLT) tile cut, and a beveled square tegular tile cut. Example dimensions related to the degree of incline, the depth, or the width of the cut are depicted in FIG. 7. It will be understood that these depictions are intended as examples of various embodiments, but are not intended to limit the possible cuts to only these depictions. In other words, different combinations of slanted edges and straight edges, depths, widths, or angles may be used in other embodiments.

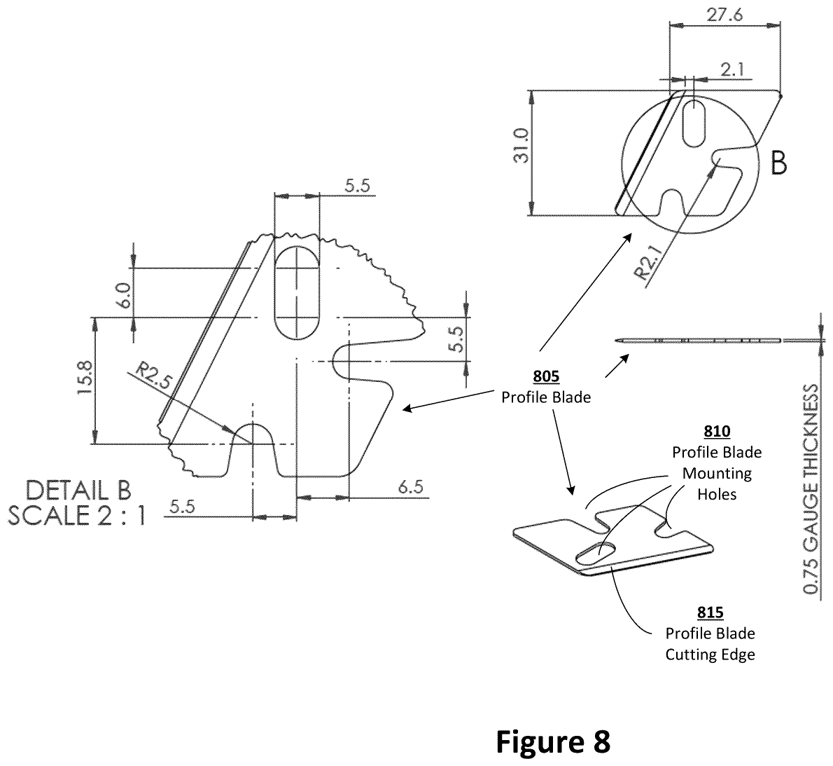

FIG. 8 depicts different example schematics of a profile blade 805 for use with the workstation 100 of FIG. 1, in accordance with various embodiments. It will be noted that the embodiment depicted in FIG. 8 is intended as one example of such a profile blade, and in other embodiments one or more of the depicted measurements may vary. Similarly to FIG. 4, the measurements depicted in FIG. 8 are in units of mm.

As may be seen in FIG. 8, the profile blade 805 may have a number of mounting holes 810. The mounting holes 810 may be configured to couple with mounting pegs of a profile blade cartridge, as will be described in greater detail below. Similarly to mounting holes 405, it will be noted that the mounting holes 810 may be sized and shaped such that they have one dimension that is different than another dimension of the mounting hole 810. As such, once the profile blade 805 is mounted with the mounting pegs positioned within the mounting holes 810, rotation of the blade may be limited. Additionally, as may be seen in FIG. 8, various of the mounting holes 810 may be positioned at an interior portion of the profile blade 805, while others of the mounting holes 810 may be positioned at an exterior portion of the profile blade 805. It will be noted with respect to the mounting holes 810 and 405, that the specific number and configuration of the mounting holes is depicted herein as one example, and other sizes/shapes/configurations/locations may be present in other embodiments.

The profile blade 805 may further have a cutting edge 815 as shown in FIG. 8. Similarly to the cutting edge 410 of the perimeter blade 315, the cutting edge 815 may be at least partially coated with TaC technology, which may provide similar benefits to the profile blade 805 as described above with respect to the perimeter blade 315. Such benefits are not re-iterated here for the sake of lack of redundancy.

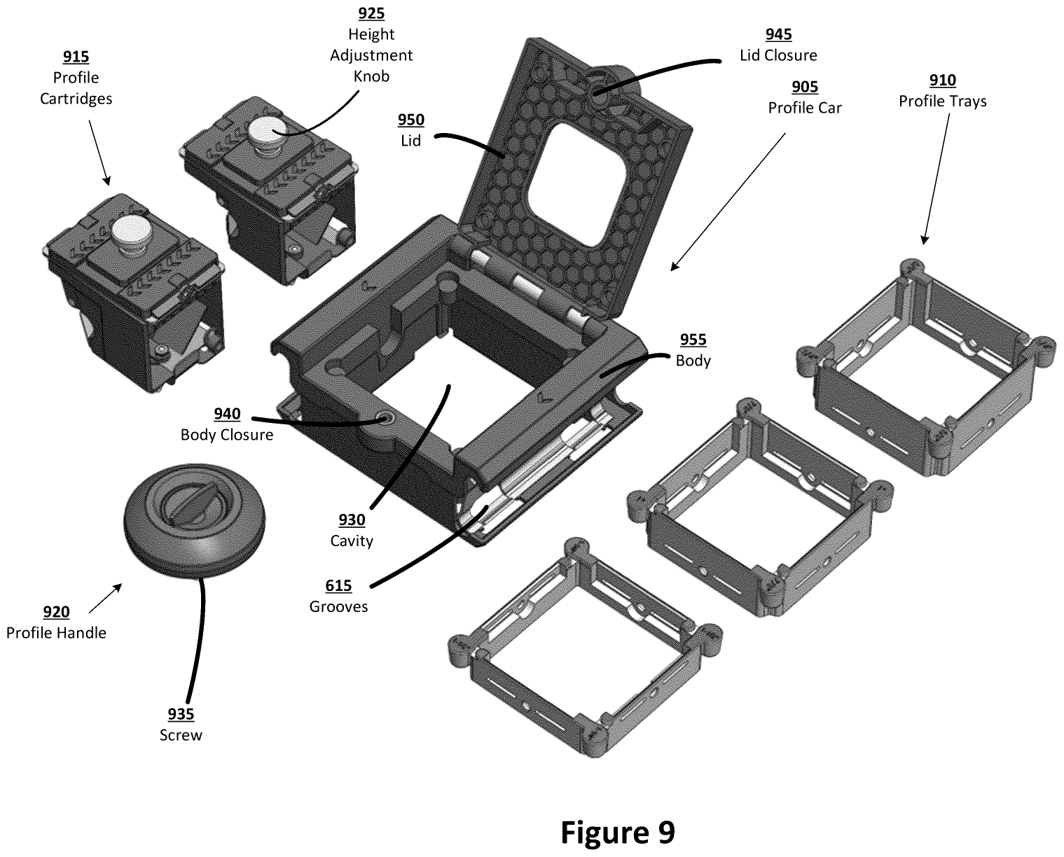

FIG. 9 depicts example of different components that may be included in a profile cutting element 305, in accordance with various embodiments.

The profile cutting element 305 may include a profile car 905, which may be similar to perimeter car 605. Specifically, the profile car 905 may include grooves 615 which may allow the profile car 905 (and the profile cutting element 305 in general) to travel along rails 115. It will be noted, however, that in other embodiments the profile car 905 may interact or couple with the rails 115 in another configuration as described above with respect to the perimeter car 605 (e.g., sitting atop the rails, having one of the rails go “through” the perimeter car 605, etc.).

The profile cutting element 305 may further include one or more profile cartridges 915, which may be placed within the cavity 930 of the profile car 905. Similarly to the perimeter cartridges 505, the profile cartridge 915 may be configured to couple with the profile blade 805 as will be described in further detail below.

Prior to being placed in the cavity 915, a profile cartridge 915 may be placed within a profile tray 910. As may be seen, the different profile trays 910 may have two different measurements. The measurements may provide height adjustments for the cartridges 915, thereby allowing for a true factory reveal edge to be made to tile thicknesses ranging from ⅝″, ¾″, ⅞″, 1″, 1¼ ″ and 1½ ″. Dependent on the orientation of the profile tray 910, each tray 910 may have two different thicknesses. For example, it may be seen that the tray to which the arrow is point may allow for a thickness of ¾″ and ⅝″, dependent on how the tray is oriented.

Additionally, as described previously, the tiles may have some degree of thickness variance due to imprecision in the manufacturing process. The thickness variance may be as much as 1/16″. To accommodate for this variance, the profile cartridges 915 may include a height adjustment knob 925. By turning the knob 925, a screw-like mechanism within the profile cartridge 915 may raise or lower the profile cartridge 915 within the profile tray 910 and, ultimately, the profile car 905. In this way, the height of the profile cut (e.g., such as those shown in FIG. 7) may be precisely controlled.

Further, a profile handle 920 may be configured to couple with the profile car 905. As may be seen, the profile handle 920 may have a screw 935 that may interact with both a lid closure 945 and a body closure 940 to secure the lid 950 to the body 955 of the profile car 905 when a profile cartridge 915 is placed in the cavity 930. Conveniently, the profile handle 920 may further act as a handle that allows a user to manipulate the profile cutting element 305 along the rails 115.

It will be noted, however, that this type of screw-based mechanism for the height adjustment knob 925 and/or the screw 935 are described herein as example embodiments, and other embodiments may use some other mechanism that performs a similar function (e.g., a snap-based enclosure, a locking-type enclosure, a ratchet type mechanism, etc.).

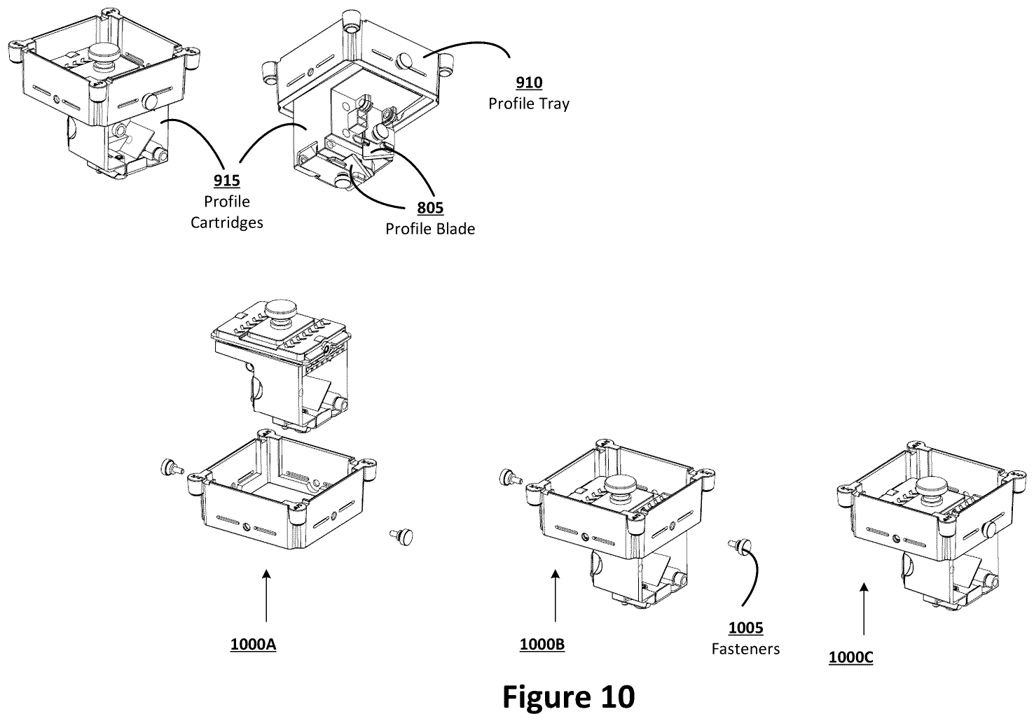

FIG. 10 depicts an example of a profile cartridge 915 mounting to a profile tray 910, in accordance with various embodiments. As may be seen in FIG. 10, the profile cartridge 915 in this example may include a plurality of profile blades 805 attached thereto. Such an arrangement may be configured to generate a square tegular cut.

As may be seen at 1000A and 1000B, the profile cartridge 915 may be lowered into a profile tray 910. In this embodiment, the profile tray 910 may be oriented to provide for a cut at a depth of ¾″ (which may be further variable based on manipulation of the height adjustment knob 925). One or more fasteners 1005 may then be inserted into the profile tray 910 to hold the profile cartridge 915 in place as seen at 1000 C. As previously described, it will be understood that this type of screw-based fastener 1005 may be one example, and other embodiments may include different types/numbers of fasteners.

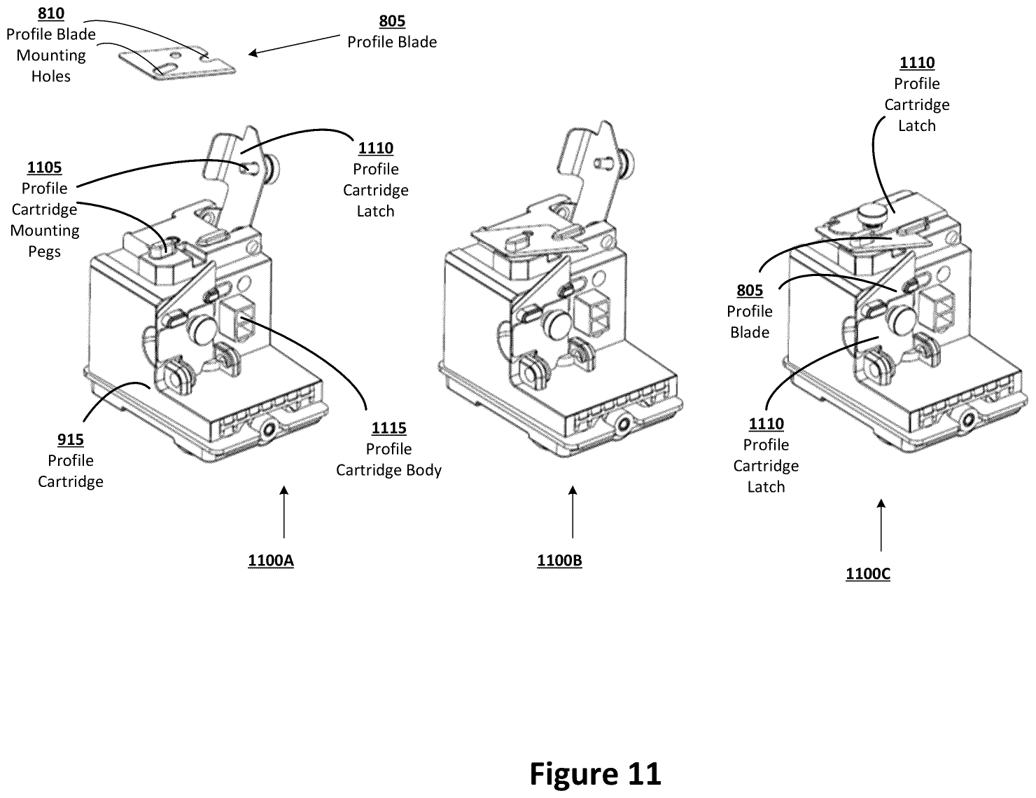

FIG. 11 depicts an example of installation of profile blades to a profile cartridge, in accordance with various embodiments. Specifically, as may be seen in FIG. 11 and as previously described, a profile blade 805 may include one or more profile blade mounting holes 810.

As seen at 1100A, a profile cartridge 915 may include a plurality of mounting pegs 1105. Some of the mounting pegs 1105 may be on the profile cartridge body 1115, while one or more mounting pegs may additionally or alternatively be located on the profile cartridge latch 1110.

At 1100B, the profile blade 805 may be situated on the profile cartridge body 1115 such that various of the pegs 1105 align with the mounting holes 810. The latch 1110 may then be closed as may be seen at 1100 C, thereby securing the blade 805 at least partially within the profile cartridge 915. Similarly to the perimeter blade cartridge described with respect to FIG. 5, it will be noted that the various mounting pegs 1105 may secure both the position and the rotation of the profile blade 805. It will also be noted that, as seen at 1100 C, the profile cartridge 915 may include a plurality of latches 1110 and be configured to couple with a plurality of profile blades 805.

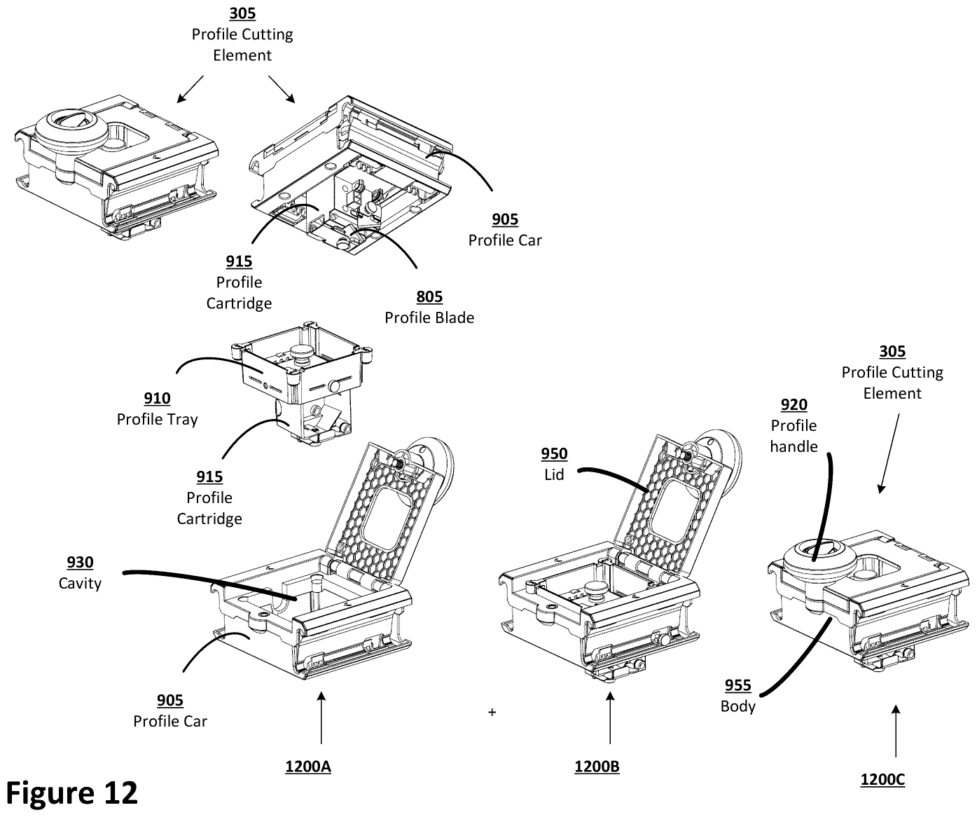

FIG. 12 depicts an example of installation of a profile cartridge 915 to a profile car 905 to form a profile cutting element 305, in accordance with various embodiments. As may be seen, the profile cutting element may include a plurality of profile blades 805.

At 1200A, a profile tray 910 and profile cartridge 915 may be aligned with the cavity 930 of a profile car 905. At 1200B, the cartridge 915 and tray 910 may be placed in the cavity 930. At 1200 C, the lid 950 may be closed, and the profile handle 920 may be used to secure the lid 950 to the body 955 as previously described.

Although certain embodiments have been illustrated and described herein for purposes of description, this application is intended to cover any adaptations or variations of the embodiments discussed herein.

In the preceding detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the preceding detailed description is to be taken as an illustrative description of various embodiments, rather than taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner. Specifically, were the disclosure recites “a” or “a first” element or the equivalent thereof, such disclosure includes one or more such elements, neither requiring nor excluding two or more such elements. Further, ordinal indicators (e.g., first, second, or third) for identified elements are used to distinguish between the elements, and do not indicate or imply a required or limited number of such elements, nor do they indicate a particular position or order of such elements unless otherwise specifically stated.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

1. A workstation comprising:
a cutting tray;
one or more rails;
a perimeter cutting element configured to travel along the rails, wherein the perimeter cutting element includes a perimeter blade mounted at least partially within a perimeter cartridge; and
a profile cutting element configured to travel along the rails, wherein the profile cutting element includes a profile blade mounted at least partially within a profile cartridge.

2. The workstation of claim 1, wherein the workstation is configured to trim a length or width of an acoustic ceiling tile when the perimeter cutting element travels along the rails.

3. The workstation of claim 1, wherein the workstation is configured to cut a profile along an edge of an acoustic ceiling tile when the profile cutting element travels along the rails.

4. The workstation of claim 3, wherein the profile is a square tegular tile cut, a slanted tile cut, or a beveled square tegular tile cut.

5. The workstation of claim 1, wherein the profile cutting element further includes a profile tray that at least partially surrounds the profile cartridge within a car of the profile cutting element.

6. The workstation of claim 5, wherein the tray is configured to adjust a height of the profile cartridge within the profile cutting element.

7. The workstation of claim 6, wherein the profile cartridge further includes a height adjustment mechanism to further adjust the height of the profile cartridge by at least 1/16″.

8. The workstation of claim 5, wherein the tray is configured to adjust the height of the profile cartridge to a height of ⅝″, ¾″, ⅞″, 1″, 1¼″, or 1½ ″.

9. The workstation of claim 1, wherein the perimeter blade has a non-circular mounting hole.

10. The workstation of claim 9, wherein the non-circular mounting hole is positioned at an interior portion of the perimeter blade.

11. The workstation of claim 9, wherein the non-circular mounting hole is configured to couple with a non-circular mounting peg of the perimeter cartridge.

12. The workstation of claim 1, wherein the profile blade has a non-circular mounting hole.

13. The workstation of claim 12, wherein the non-circular mounting hole is positioned at an interior portion of the profile blade.

14. The workstation of claim 12, wherein the non-circular mounting hole is configured to couple with a non-circular mounting peg of the profile cartridge.

15. The workstation of claim 1, wherein a cutting edge of the perimeter blade and/or the profile blade is at least partially covered with a Tetrahedral Amorphous Carbon diamond coating.
